(19) United States
(12) Patent Application Publication
(10) Pub. No.: US 2014/0130989 A1
(43) Pub. Date: May 15, 2014

(54) WINDOW DRESSING CONTROL DEVICE

(71) Applicants: Louis Chan, Dover (DE); Zhao Jun, Zhejiang (CN); Ding Chun Cheng, Zhejiang (CN)

(72) Inventors: Louis Chan, Dover (DE); Zhao Jun, Zhejiang (CN); Ding Chun Cheng, Zhejiang (CN)

(21) Appl. No.: 13/674,488

(22) Filed: Nov. 12, 2012

(51) Int. Cl. E06B 9/90; E06B 9/68

(52) U.S. Cl. CPC E06B 9/90; E06B 9/68
USPC 160/309; 242/396.8; 242/389

(57) ABSTRACT

A window dressing control device includes a housing defining a base, an axially extending hollow cylinder, and an axially extending central shaft, the cylinder and shaft each projecting from the base so as to be substantially parallel and coaxial. The device also includes at least one resilient member between the cylinder and the shaft; a rotatable spool coupled to the housing about the cylinder, and a clutch device mounted on the spool. The resilient member engages the spool and the clutch device, providing a friction brake that bears on the inner wall of the cylinder (or a reinforcing insert within the cylinder) to resist rotation of the spool and clutch.

### TECHNICAL FIELD

This specification generally relates to window dressing devices. In particular, one or more embodiments described below feature window dressing control devices and end pin devices for window dressing control assemblies.

### BACKGROUND

Window dressing control assemblies typically include a main roll tube, which carries the window dressing, supported for rotation by mounting brackets disposed at both ends of the window dressing. A window dressing control device is typically positioned at one end to facilitate rotation of the main roll tube by a user via a drive chain. An end pin device is typically positioned at the other end of the main roll tube.

### SUMMARY

This specification describes technologies related to systems, apparatus, and methods for window dressing devices (e.g., window dressing control devices and end pin devices for window dressing control assemblies).

In one aspect, the systems, apparatus, and methods disclosed herein feature a window dressing control device including: a housing defining a base, an axially extending hollow cylinder, and an axially extending central shaft, the cylinder and shaft each projecting from the base so as to be substantially parallel and coaxial; at least one resilient member between the cylinder and the shaft; a spool coupled to the housing so as to be rotatable about the cylinder, the spool including a first element projecting between the cylinder and the shaft and engaging the at least one resilient member such that rotation of the spool causes section(s) of the at least one resilient member to radially contract; and a clutch device mounted on the spool and including a second element projecting between the cylinder and the shaft to engage the at least one resilient member, the clutch device configured to carry a counterweight causing the second element to engage the at least one resilient member and bias the section(s) of the at least one resilient member to radially expand.

In some examples, the at least one resilient member includes two or more resilient members positioned coaxially about the central shaft. In some cases, the two or more resilient members includes an even number of resilient members.

In some implementations, the window dressing control device further includes a reinforcing insert fixedly positioned against an inner cylindrical wall of the cylinder. In some examples, the reinforcing insert includes a metallic material. In some embodiments, the reinforcing insert is integrally fused with the cylinder. In some applications, the reinforcing insert is configured to engage the coil section of the at least one resilient member, when the coil section radially expands.

In some applications, the window dressing control device further includes an endless cord member coupled to the spool operable to drive rotation of the spool when pulled by a user. In some examples, the endless cord member includes a beaded chain, a nylon cord, or a polyester cord.

In some cases, the window dressing control device further includes a hollow tube mounted on the clutch device and configured to support a window dressing, such that the counterweight carried by clutch device is proportional to the weight of the window dressing.

In some embodiments, the window dressing control device further includes a mounting bracket removably attached to the housing for mounting the housing to a support surface.

In another aspect, the systems, apparatus, and methods disclosed herein feature a window dressing control device including: a housing defining a base, an axially extending hollow cylinder, and an axially extending central shaft, the cylinder and shaft each projecting from the base so as to be substantially parallel and coaxial; at least one wrap spring positioned between the cylinder and the shaft, each at least one wrap spring including a coil section and radially extending tangs; a spool coupled to the housing so as to be rotatable about the cylinder, the spool including a first cam element projecting between the cylinder and the shaft and engaging the at least one wrap spring, such that rotation of the spool causes the first cam element to bear on a first side of the tangs of the at least one wrap spring and cause the coil section(s) of the at least one wrap spring to radially contract; and a clutch device mounted on the spool and including a second cam element projecting between the cylinder and the shaft to engage the at least one wrap spring, the clutch device being configured to carry a counterweight causing the second cam element to bear on a second side of the tangs of the at least one wrap spring and bias the coil section(s) of the at least one wrap spring to radially expand.

In some examples, the at least one wrap spring includes two or more wrap springs positioned coaxially about the central shaft. In some embodiments, the two or more wrap springs include an even number of wrap springs.

In some implementations, the window dressing control device further includes a reinforcing insert fixedly positioned against an inner cylindrical wall of the cylinder. In some cases, the reinforcing insert includes a metallic material. In some applications, the reinforcing insert is integrally fused with the cylinder. In some examples, the reinforcing insert is configured to engage the coil section of the at least one wrap spring when the coil section radially expands.

In another aspect, the systems, apparatus, and methods disclosed herein feature a roller shade end pin assembly, including: an outer housing; an end pin housing rotatably mounted coaxially within the housing, the end pin housing defining an open end opposite a base; an end pin mounted coaxially within the end pin housing, the end pin having a first mounting projection; at least one first resilient member disposed between the end pin and the end pin housing, the at least one first resilient member biasing the end pin away from the base of the end pin housing; and a split end pin component slidably mounted on the end pin, the split end pin component having a second mounting projection; and at least one second resilient member disposed between the split end pin component and the end pin housing, the at least one second resilient member biasing the split end pin component away from the base of the end pin housing. When at maximum separation from the base of the end pin housing, the first mounting projection and the second mounting projection together define a cylindrical outer surface.

In some applications, the first mounting projection is semi-cylindrical and the second mounting projection is semi-cylindrical.

In some cases, the split end pin component is supported on the end pin such that movement of the split end pin component towards the base of the end pin housing exposes the first mounting projection of the end pin for engagement with a complementary first mounting projection of another roller shade end pin assembly.

In some embodiments, the end pin includes features that engage the end pin housing and limit movement of the end pin away from the base of the end pin housing.

In some examples, the split end pin component includes features that engage the end pin and limit movement of the end pin away from the base of the end pin housing.

Some embodiments of window dressing control devices and end pin devices for window dressing assemblies can provide one or more of the following advantages.

Window dressing control devices as described herein can be used in a wide variety of applications with different window dressings of different sizes and shapes. For example, the devices can be designed with a reinforcing insert that interacts with the springs which provide the greater friction breaking system. This design allows each of the springs to bear more weight without damaging the supporting housing. As a result, the same amount of resistive force can be achieved with fewer springs and a smaller housing. Several advantageous are provided by such an arrangement. For example, greater braking force is achieved with less hardware (e.g., springs), which may provide cost savings and/or reduce maintenance issues. Further, as mentioned above, the increased braking capability allows the device to be used in a smaller housing unit appropriate for a wide variety of applications.

The described end pin devices can be connected with the end pin device of an adjacent window dressing assembly such that the two window dressings can be operated independently while mounted at their ends with a shared bracket. Moreover, this arrangement can provide advantages relative to techniques where two adjacent window dressings are mounted separately. In particular, the shared bracket arrangement enabled by the end pin device is more aesthetically pleasing because adjacent window dressings can be mounted with very little hardware exposed between them. The shared bracket arrangement can also be more cost efficient than separately mounted adjacent window dressing assemblies, requiring only one bracket between the end pins of two window dressing assemblies. This arrangement also provides a small light gap between two adjacent window dressings, which offers greater privacy when the window dressings span a single large window.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a perspective view of a window dressing control device coupled to a mounting bracket.

FIG. 2 is an exploded view of the window dressing control device of FIG. 1.

FIG. 3 is a cross-sectional view of the window dressing control device of FIG. 1.

FIG. 4 is a perspective view of a spool incorporated in the window dressing control device of FIG. 1.

FIG. 5 is a perspective view of a clutch tube incorporated in the window dressing control device of FIG. 1.

FIG. 6 is a perspective view of a wrap spring incorporated in the window dressing control device of FIG. 1.

FIG. 7 is perspective view of an end pin device.

FIG. 8 is an exploded view of the end pin device of FIG. 7.

FIG. 9 is a cross-sectional view of the end pin device of FIG. 7.

FIG. 10 is a perspective view of an end pin incorporated in the end pin device of FIG. 7.

FIG. 11 is a split end pin incorporated in the end pin device of FIG. 7.

Many of the levels, sections and features are exaggerated to better show the features, process steps, and results. Like reference numbers and designations in the various drawings indicate like elements.

### DETAILED DESCRIPTION

One or more implementations described in the present disclosure include a window dressing clutch device featuring an inverted friction breaking system adapted with a reinforcing element that inhibits wear on the supporting housing. Generally, this type of design provides a more powerful braking system, without increasing the amount of hardware, and, in some embodiments, reduces the amount of hardware required.

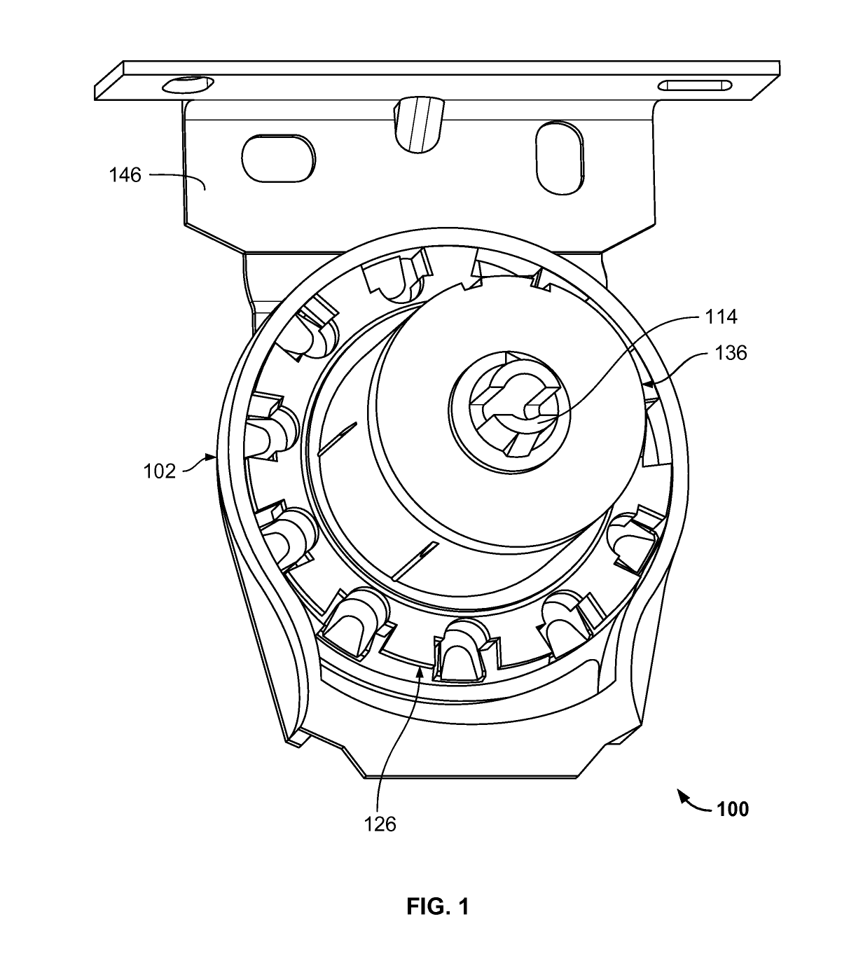

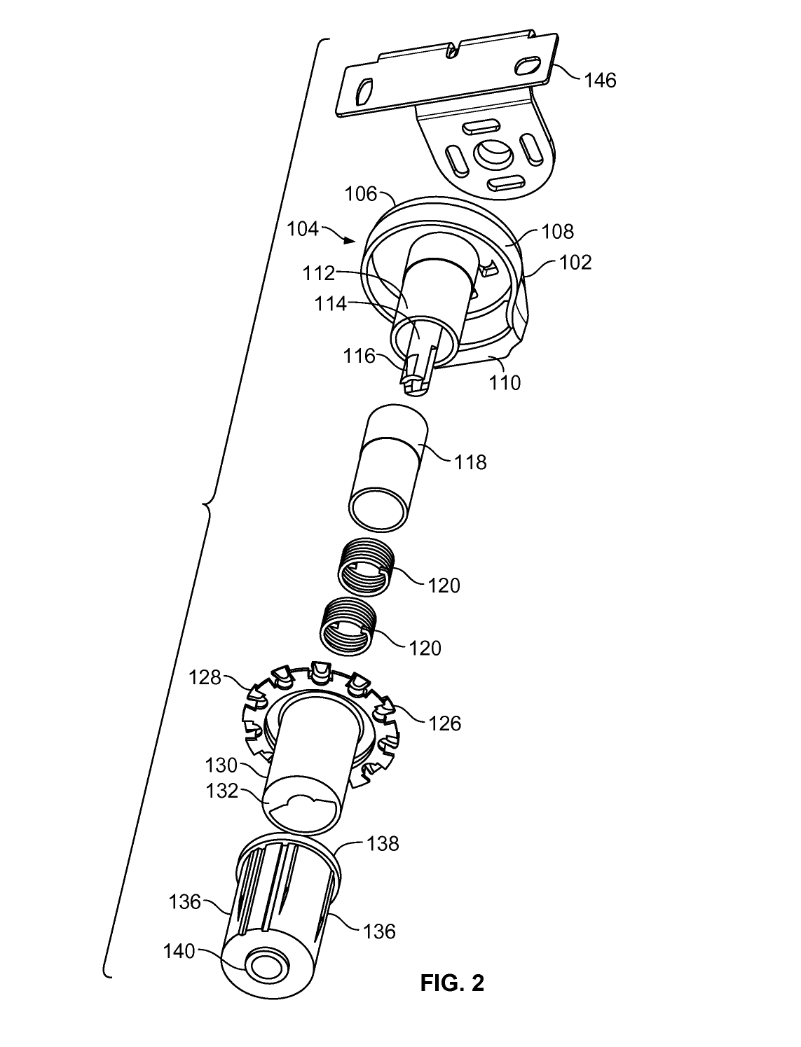

FIGS. 1-3 show an example window dressing control device 100. The device 100 features a housing 102 supporting a reinforcing insert 118, multiple resilient members (e.g., wrap springs 120), a spool 126, and a clutch tube 136. The housing 102 is removably coupled to a mounting bracket 146 used to affix the device 100 to a supporting surface (e.g., a wall, a bulkhead, etc.).

The housing 102 is a monolithic structure (e.g., a molded structure) defining a base 104, a cylindrical drum 112, and a central shaft 114. In some embodiments, the housing can be assembled from discrete components rather than provided as a single monolithic structure. The base 104 includes a flat back plate 106 circumscribed by a raised lip 108. The back plate 106 is generally circular in shape, opening at one section to form an open mouth 110. The cylindrical drum 112 extends axially outward from the back plate 106 and defines a hollow bore. The central shaft 114 extends outward from the back plate 106 coaxially with the drum 112, such that the shaft is positioned within the bore. The diameter of the bore is larger than that of the central shaft so that a space exists between the shaft and the inner wall of the drum 112. The central shaft 114 extends beyond the drum 112. The distal end of the central shaft 114 defines a set of snap engagement features 116 for securing other components of the device 100 to the housing 102. In some embodiments, other types of coupling or fittings (e.g., threaded couplings, friction fittings, twist lock assemblies, etc.) can be used to secure other components of the device 100 to the housing 102. The central shaft can have an outer diameter, for example, between about 10 mm and 7 mm (e.g., between about 9 mm and 8 mm). The cylindrical drum can have an inner diameter, for example, between about 25 mm and 20 mm (e.g., between about 24 mm and 23 mm, or about 21.3 mm).

The reinforcing insert 118 fits inside of the bore of the drum 112. For example, the reinforcing insert 118 can be press fit or adhered to the inner wall of the drum 112. In some examples, the reinforcing insert 118 is integrally fused with the inner wall of the drum 112. For instance, the reinforcing insert 118 can be placed into an injection mold used to form the housing 102 so that the insert and the molded housing become fused together. The reinforcing insert 118 is designed to engage the wrap springs 120 (as described below) in order to prevent wear on the drum 112. Accordingly, the reinforcing insert 118 can be fashioned from a material that offers more strength and/or hardness than the material of the housing 102. For example, the reinforcing insert 118 can be a formed from a metallic material (e.g., steel, aluminum, reinforced resin, etc.) and the housing 102 can be formed from a plastic material (e.g., nylon with 30% fiberglass, polyoxymethylene, acrylonitrile-butadiene-styrene, and polybenzothiazole). The reinforcing insert can have an inner diameter, for example, between 22 mm and 16 mm (e.g., between about 21 mm and 17 mm, between about 20 mm and 18 mm, or about 16.3 mm).

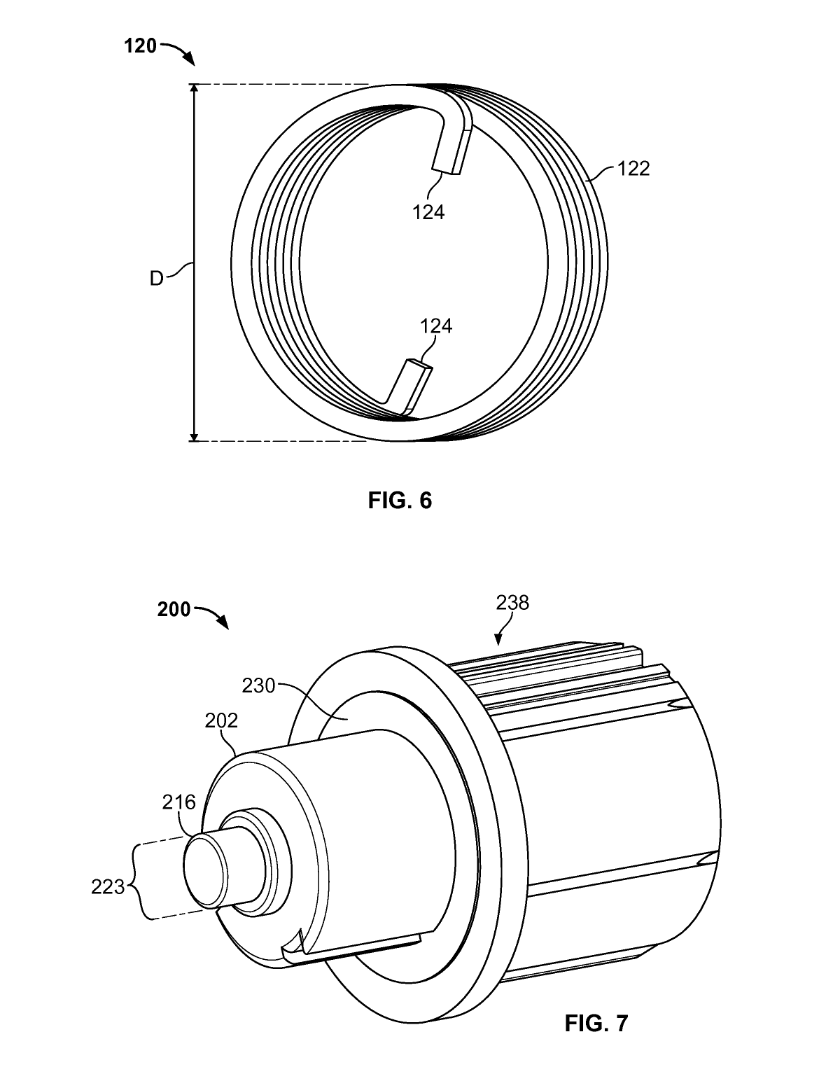

The wrap springs 120 are situated within a cavity defined by the reinforcing insert 118. The springs 120 include an axial coil section 122 terminating at either end with a tang 124 extending radially inward (see FIG. 6). The tangs are configured to engage cam elements on the spool 126 and the clutch 126 as described below such that forces applied to the tangs by the spool and clutch, as described below, can cause the axial coil section 122 of the wrap springs 120 to contract or expand. The springs 120 are wound such that the coil sections 122 have a natural diameter D. The natural diameter D is selected such that interaction between the springs 120 and cam elements provided on the spool 126 and the clutch 126 can cause the axial coil section 122 of the wrap springs 120 to contract and disengage from the reinforcing insert or expand and engage the reinforcing insert.

Some embodiments omit the reinforcing insert. In these embodiments, the wrap springs can directly engage the cylindrical drum 112 of the housing 102.

In some embodiments, the device 100 can be formed with wrap springs having a natural diameter D of 16.2 mm, a central shaft having an outer diameter of 8.5 mm, and the cylindrical drum having an inner diameter, for example, between 16.3 mm.

In the illustrated embodiment, the springs 120 are formed from a metal wire having a rectangular cross-section. The metal wire is wound in adjacent coils such that the coil section 122 provides an inner cylindrical surface that is effectively continuous. The springs 120 can vary in wire size, wire cross-section, and wire material between various applications and embodiments. Some embodiments include springs with wire sizes such as, for example, about 16 mm to 20 mm (e.g., about 16.2 mm). Some embodiments include springs with wire cross-sections such as, for example, circular, hexagonal, etc. Some embodiments include springs made of materials such as, for example, piano wire, 1 mm×1 mm square wire, 1.5 mm×1.5 mm square wire, 0.8 mm×0.8 mm square wire, and 1 mm round wire or 1.4 mm round wire], etc.

In the illustrated example, the device is designed with two wrap springs that engage the spool and clutch. However, any appropriate number of springs (e.g., one, three, four, five, six or more springs) can be used without departing from the scope of this disclosure. Increasing the number of springs increases the weight of the window dressing that can be supported. In many cases, it is advantageous to use an even number of springs for the purpose of counterbalancing as discussed below.

The tangs 124 are designed to facilitate contraction and expansion of the coil section(s) 122. That is, the tangs 124 are configured to engage a cam element to facilitate clockwise or counterclockwise twisting of the resilient member(s) (e.g., wrap spring 120), loosening or tightening the coils to increase or decrease the coil diameter D. For counterbalancing purposes, the springs 120 can be wounded oppositely and positioned such that twisting the metal wire of some springs in a clockwise direction will radially contract their coil section 122, while clockwise twisting of the metal wire of other springs will radially expand their coil sections, and vice versa for counterclockwise twisting. The springs could also be wound in the same direction without departing from the scope of the present disclosure. In some examples, the springs can be arranged in an alternating pattern, such that each spring is placed adjacent to an oppositely wound spring. Various other types of patterns for arranging the springs are also contemplated.

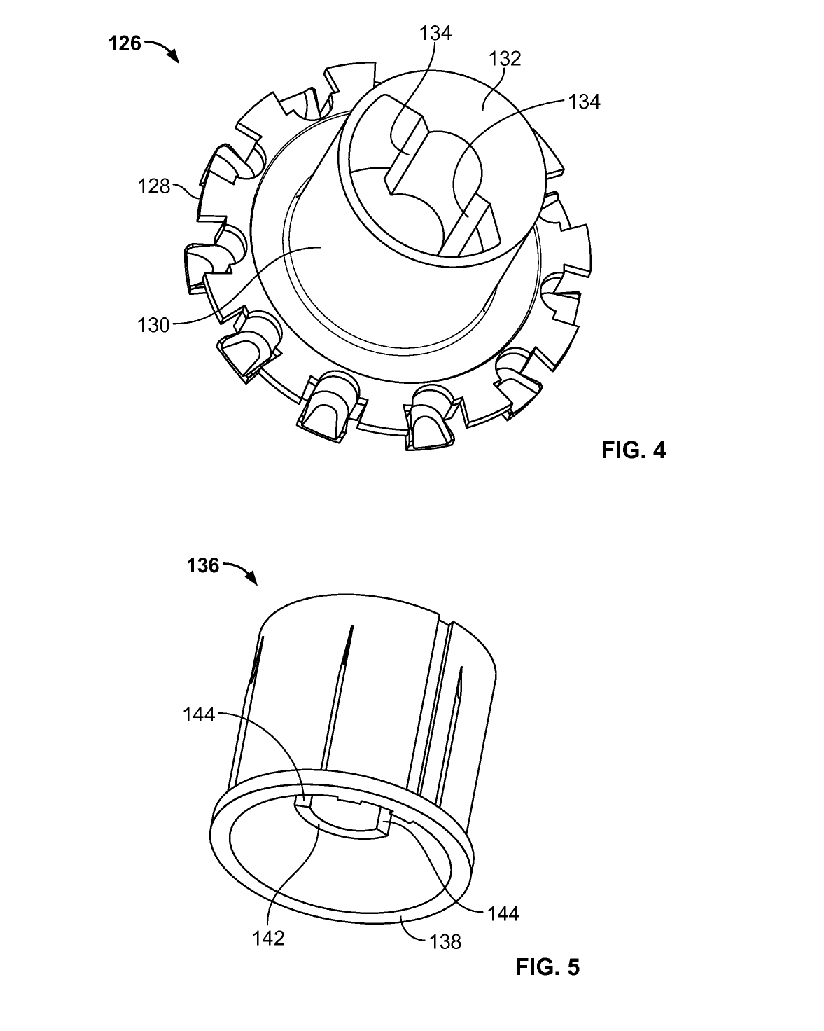

The spool 126 is rotatably mounted on the outer surface of the drum 112. The spool 126 includes a wheel (e.g., chain wheel 128) and a tubular cam housing 130 extending axially outward from the wheel (see also FIG. 4). The wheel 128 is a circular disk configured to engage a pull mechanism. For example, the wheel 128 can be a chain wheel defining alternating teeth and grooves (e.g., disposed along its circumferential edge or internally) configured to receive a beaded drive chain (not shown) or a polyester or nylon cord. For example, a drive chain can drive rotation of the spool 126 when a user pulls the drive chain through the chain wheel 128.

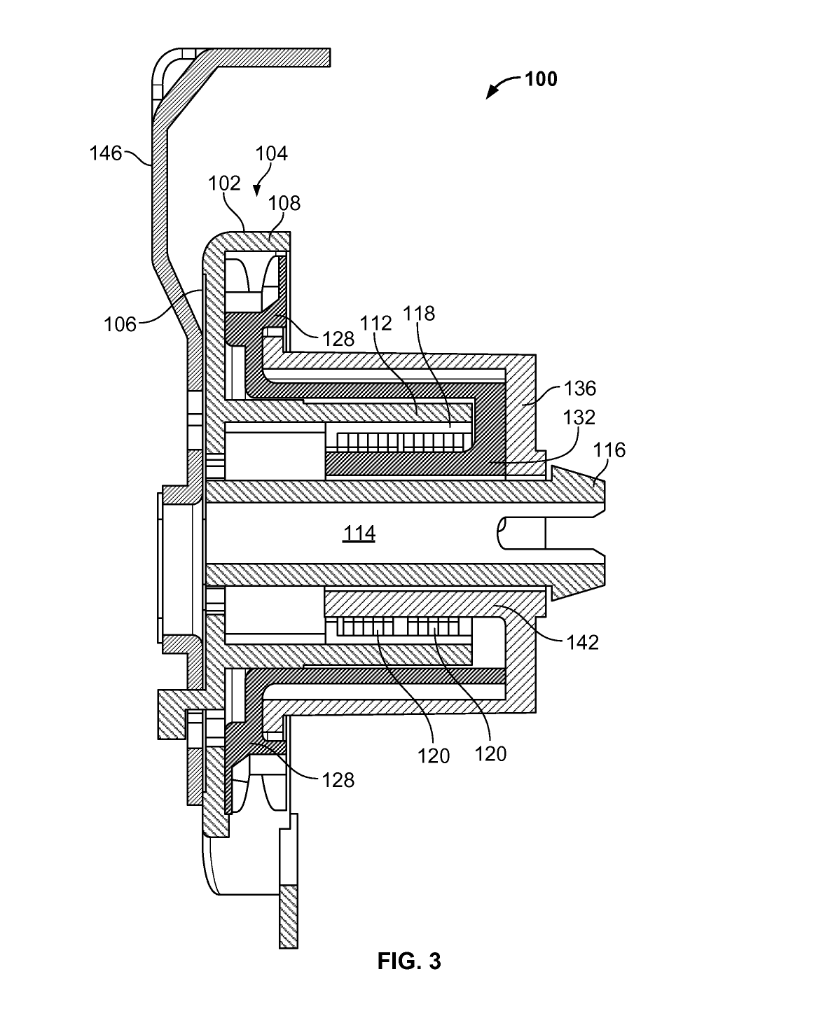

The cam housing 130 is a cylindrical body extending integrally outward in the axial direction from the chain wheel 128 to define an opening at the distal end. The cam housing includes a first cam element 132. The first cam element 132 is an inward radial protrusion from the distal end of the cam housing having a semi-cylindrical shape defining two exposed end surfaces 134. When the spool 126 is mounted on the outer surface of the drum 112, the first cam element 132 extends inside the bore of the drum outside of the central shaft 114 (see FIG. 3). The coil sections 122 of the springs 120 rest against the outer surface of the first cam element 132. The exposed ends 134 of the first cam element 132 serve as cam faces for engaging with the tangs 124 of the springs 120.

The clutch tube 136 is mounted on the outer surface of the tubular cam housing 130 so that the cam housing and the spool 126 rotate in tandem (for example, the clutch tube and the cam housing can be keyed to one another or simply coupled to one another via an interference fit). The clutch tube 136 is a cylindrical body defining openings 138, 140 with an opening at each axial end (see FIG. 5). The opening 138 at the proximal end of the clutch tube 136 (with respect to the housing 102) is appropriately sized to receive the cam housing 130 and can be larger than the opening 140 at the distal end of the clutch tube 136. The distal opening 140 is designed to interact with the snap engagement features 116 of the central shaft 114 to secure the assembly components in place. The outer surface of the clutch tube 136 is configured to carry a main roll tube to which the window dressing is attached.

A second cam element 142 extends axially inwards from the distal opening 140. Similar to the first cam element 132, the second cam element 142 has a semi-cylindrical shape defining two exposed end surfaces 144 that serve as cam surfaces for engaging tangs 124 of the springs 120. When the clutch tube 136 is mounted on the outer surface of the cam housing 130, the second cam element 142 extends inside the bore of the drum 112 outside of the central shaft 114 (see FIG. 3). The second cam element 142 is positioned about an opposing circumferential section of the central shaft 114 than the first cam element 132. The coil sections 122 of the springs 120 rest against the outer surface of the second cam element 142.

The springs 120 are arranged together with the first and second cam elements 132 and 142, such that the cam elements facilitate contraction and expansion of the coil sections 122 of the springs. In this example, the coil sections 122 of the springs 120 are positioned radially outside the first and second cam elements 132 and 142 with the inwardly facing tangs 124 being aligned with the respective cam surfaces 134 and 144. As noted above, the springs 120 are generally provided in oppositely wound pairs to provide a counterbalancing effect. Thus, each of the first cam element 132 and the second cam element 142 is designed to facilitate contracting of the coil section 122 of one spring 120, and simultaneous expansion of the coil section of the other spring. The coil sections are expanded and contracted (“actuated”) when the springs are twisted by rotation of the cam elements in a clockwise or counter clockwise direction. When the cam elements are rotated, the cam faces bear on the tangs to twist the metal wire. The first cam element 132 actuates the springs 120 when the spool 126 drives rotation of the clutch tube 136 (e.g., when a user pulls on the drive chain). Conversely, the second cam element 142 actuates the springs 120 when the clutch tube 136 drives rotation of the spool 126 (e.g., when the weight of the window dressing exerts a torque on the clutch tube, or when an external force is exerted on the window dressing).

The coil sections 122 of the springs 120 are designed to engage the reinforcing insert 118 when expanded radially by either of the cam elements 132 and 142. The coil sections 122 expand until they encounter and abut the reinforcing insert 118. Friction between the expanded coil sections 122 and the reinforcing insert 118 provides a resistive force against rotation of the spool 126 and the clutch tube 136. When the springs are provided in oppositely wound pairs, half of the springs will be engaged with the reinforcing insert whenever there is a force on the beaded chain or the window dressing and can provide a resistive force that remains constant. In some embodiments, the device 100 can be implemented with odd numbers of springs 120. In these embodiments, the associated forces may be balanced by using springs with different properties (e.g., spring force, etc.) or the associated forces may be unbalanced. In some implementations, the resistive force provided by the springs 120 is at least as great as the weight of the window dressing, to inhibit an unintended unwinding of the dressing from the main roll. Thus, this assembly provides a friction brake to hold the window dressing in place.

A user can overcome the friction brake by pulling on the beaded drive chain to rotate the spool 126. In particular, the user must pull on the beaded chain with sufficient force to overcome the resistive force caused by the coils 122 of the springs 120 bearing on the reinforcing insert 118, as well as any torque provided by the window dressing. In this example, the diameter of the chain wheel 128 is larger than that of the clutch tube 136 to provide a mechanical advantage for the user. For example, the diameter of the chain wheel 128 can be, for example, 25%, 50%, 75%, 100%, etc., greater than the diameter of the clutch tube 136. The chain wheel 128 can have an outer diameter, for example, between about 60 mm and 40 mm (e.g., between about 50 mm and 30 mm, or between about 45 mm and 35 mm, or about 45.2 mm). The clutch tube can have an outer diameter, for example, between about 40 mm and 30 mm (e.g., between about 37 mm and 35 mm, or about 38 mm).

As noted above, one or more of the embodiments described herein can provide greater breaking force with less hardware (e.g., springs), which may provide cost savings. The increased braking capability allows the device to be used in a wide variety of applications.

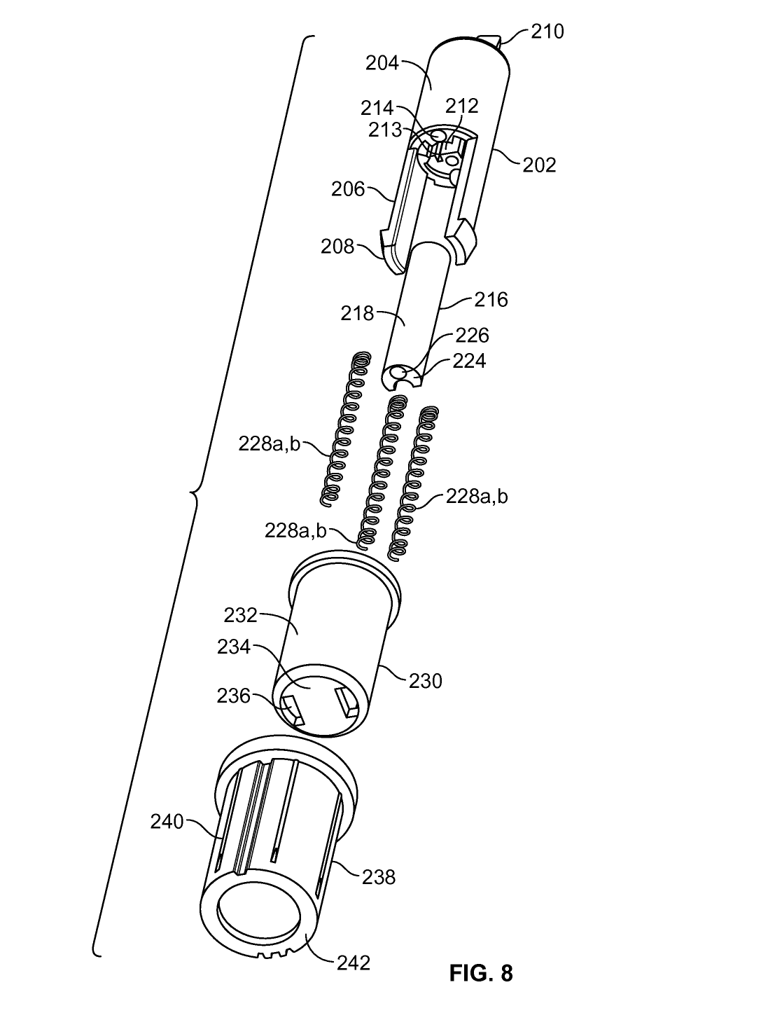

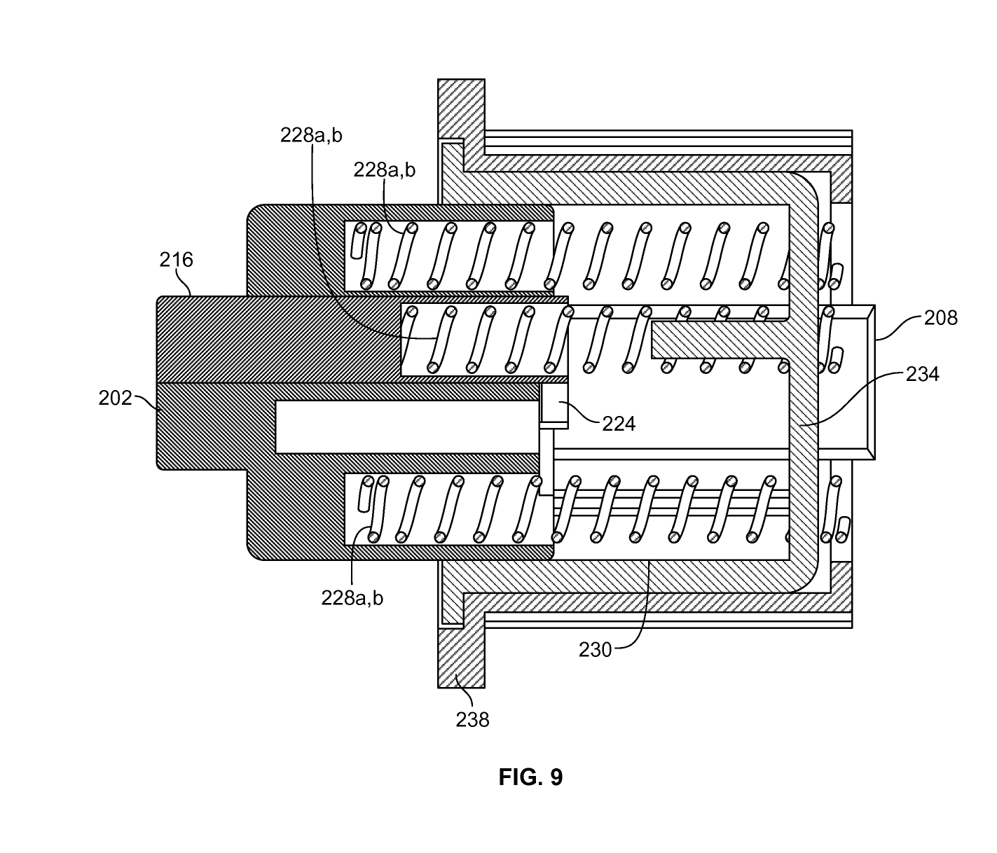

FIGS. 7-9 show an example end pin device 200 such as can be used in conjunction with the window dressing control device 100 in a window dressing assembly. The end pin device can also be used with other window dressing control devices such as, for example, control devices using other clutch mechanisms.

As described below, the end pin device 200 is configured to engage with the end pin device of another window dressing assembly such that the two window dressings can be operated independently while mounted at their ends with a shared bracket. This arrangement can provide advantages relative to techniques where two adjacent window dressings are mounted separately. In particular, the shared bracket arrangement enabled by the end pin device 200 is more aesthetically pleasing because adjacent window dressings can be mounted with reduced hardware and a small gap between them. The shared bracket arrangement can also be more cost efficient than separately mounted adjacent window dressing assemblies, requiring only one bracket between the end pins of two window dressing assemblies.

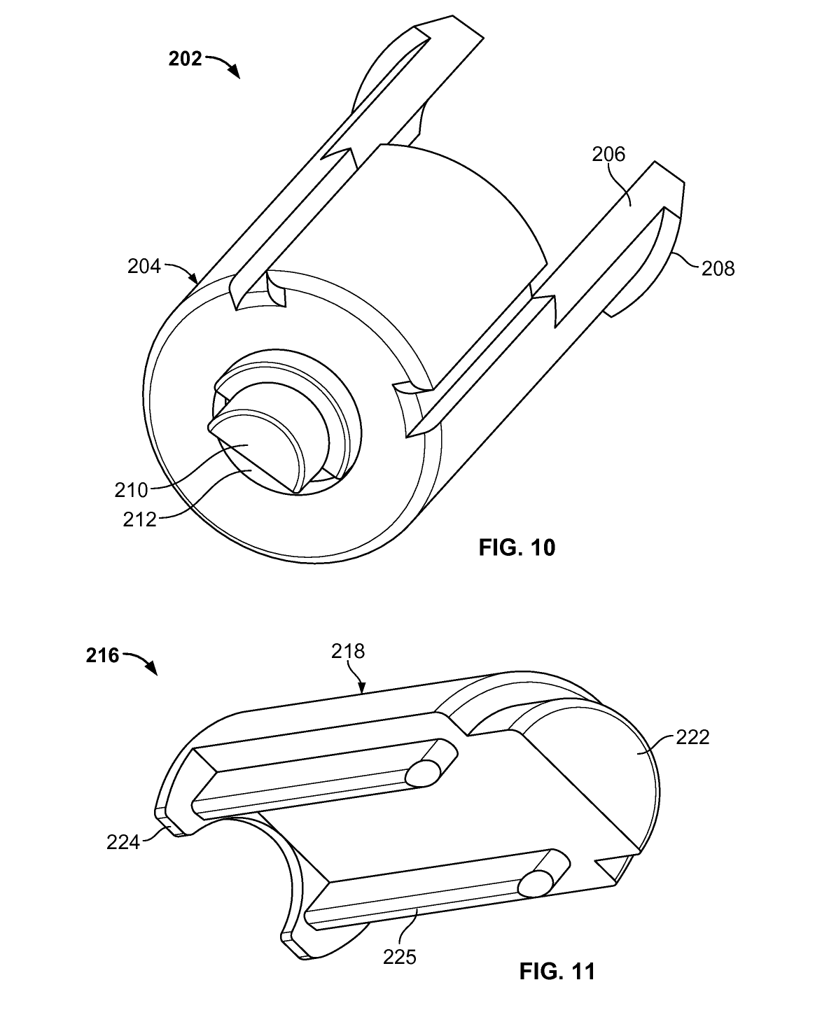

The device 200 features an end pin 202, a split end pin 216, an end pin housing 230, and an outer housing 238. The end pin 202 includes a generally cylindrical body 204 and two arms 206 extending outward from the body in an axial direction (see FIG. 10). The distal ends of the arms 206 form snap engagement features 208. A first pin protrusion 210 extends outward from a back wall of the body 204. A second pin protrusion 222 of the split end pin is complementary to the first pin protrusion 210 such that, when engaged, the first pin protrusion 210 and the second pin protrusion 222 together define a cylindrical outer surface. In the illustrated embodiment, the first pin protrusion 210 and the second pin protrusion each have a half-cylinderical shape.

The body 204 defines a slot opening 212 configured to receive the split end pin 216. The slot opening 212 is a through-hole that traverses entire length of the body 204. As shown, the slot opening 212 also has a half-cylinder shape and is located adjacent the first pin protrusion 210. Further, in order to accommodate the split end pin component 216, the slot opening 212 provides alignment tracks 213. The body 204 also defines two axial spring bores 214. The spring bores 214 are designed to receive springs 228a , which bias the end pin 202 axially away from the end pin housing 230. The springs 228a facilitate axial movement of the end pin 202 with respect to the end pin housing 230. This spring biased movement is designed to help a user install the end pin device 200 on a mounting bracket during use.

The split end pin 216 features a body 218 designed to fill the slot opening 212 of the end pin 202. In the illustrated embodiment, the body 218 has a generally half-cylindrical shape. However, the body can have other shapes such as, for example, a shape with a rectangular or circular cross-section. The body 218 is slidable in the axial direction relative to the body 204 of the end pin 202 within the slot opening 212. The body 218 at one end defines a second pin protrusion 222 that is complementary to the first pin protrusion 210. The opposite end of the body 218 defines a stop plate 224 configured to abut the body 204 of the end pin 202 in order to prevent the split end pin 216 from sliding out of the back side of the slot opening 212 and becoming dislodged from the device. A set of optional alignment rails 225 are located on the base of the body 218 (see FIG. 11). Alignment rails 225 are designed to align with the tracks 213 of the slot opening 212 to facilitate sliding movement of the split end pin 216 with respect to the end pin 202.

The split end pin 216 is movable between a retracted position, where the second pin protrusion 222 is disposed inside the slot opening 212, and an advanced position, where the second pin protrusion is exposed beyond the slot opening. The advanced position (see FIG. 7) the first and second pin protrusions 210 and 222 are positioned face to face to form a full cylindrical protrusion 223. Similar to the end pin 216, a spring bore 226 is provided in the split end pin 216 to receive a spring 228b that biases the split end pin 216 away from the end pin housing 230. The spring 228b biases the split end pin 216 towards the advanced position.

The end pin housing 230 features a cylindrical body 232 defining an opening at one end for receiving the end pin 202. The other end of the end pin housing 230 features an end plate 234 that engages the springs 228a and 228b. The end plate 234 includes apertures 236 designed to receive the distal ends of the arms 206, thus keying the end pin 202 to the end pin housing 230.

The outer housing 238 features a tubular body 240 designed to carry the main roll tube holding the window dressing, such that the outer housing rotates with the main roll tube as the window dressing clutch device 100 is operated by a user. The outer housing 238 is open at both ends. A first opening is designed to accommodate the end pin housing 230 into the hollow interior of the tubular body 240. The end pin housing 230 is aligned coaxially with the outer housing 238, such that the outer housing is rotatable about the end pin housing. The opposite end of the outer housing 238 features an opening circumscribed by a retaining lip 242 that interacts with the snap engagement features 208 of the end pin 202 to hold the various components of the device in place.

When a window dressing assembly is installed, the end pin device 200 is secured to a mounting bracket affixed to a supporting surface. The mounting bracket would include a circular opening for retaining the cylindrical protrusion 223, and thereby coupling the end pin device 200 to the mounting bracket. In some examples, the cylindrical protrusion 223 is fixed in place by the mounting bracket. However, in some other examples, it may be advantageous to allow the cylindrical protrusion 223, and thus the end pin 202, to freely rotate with respect to the mounting bracket in order to provide an additional means of rotation for the main roll tube carrying the window dressing. For example, in some cases, the weight of a large window dressing might cause a significant amount of friction between the outer housing 238 and the end pin housing 230. If the friction force is large enough, it may inhibit rotation between the outer housing 238 and the end pin housing 230. This type of friction is generally caused by a slight bowing of the main roller tube when an especially long window dressing is used. In this case, there may be significantly less friction between the cylindrical protrusion 223 and the mounting bracket, allowing the entire end pin device 200 to rotate with the main roll tube. Thus, the additional means of rotation allows the window dressing to be moved with less force by the user than would be required to overcome the additional friction between the outer housing 238 and the end pin housing 230.

As noted above, the end pin device 200 is designed to mate with another corresponding end pin device. To couple the two end pin device together, the first pin protrusion 210 of each device is pressed against the second pin protrusion 222 of the other device, forcing the respective second pin protrusions back against the spring force into the retracted position within the slot opening 212. The respective first pin protrusions, now face to face, form a cylindrical protrusion that fits into the opening of a shared mounting bracket. Further, because rotation of the main roll tube for the window dressing is divorced from the end pin 202 itself (that is, the main roll tube rotates with the end pin housing 230 that is freely rotatable on the end pin housing 230), the window dressing associated with each of the end pin devices can be operated independently.

The use of terminology such as “front,” “back,” “top,” “bottom,” “over,” “above,” and “below” throughout the specification and claims is for describing the relative positions of various components of the system and other elements described herein. Similarly, the use of any horizontal or vertical terms to describe elements is for describing relative orientations of the various components of the system and other elements described herein. Unless otherwise stated explicitly, the use of such terminology does not imply a particular position or orientation of the system or any other components relative to the direction of the Earth gravitational force, or the Earth ground surface, or other particular position or orientation that the system other elements may be placed in during operation, manufacturing, and transportation.

A number of embodiments of the invention have been described. Nevertheless, it will be understood that various modifications may be made without departing from the spirit and scope of the disclosure.

For example, in some embodiments, resilient members other than wrap springs are used to engage the reinforcing insert. In another example, the reinforcing insert is omitted and the wrap spring or other resilient member directly engages inner surfaces of housing cylinder.

What is claimed is:

1. A window dressing control device comprising:
a housing defining a base, an axially extending hollow cylinder, and an axially extending central shaft, the cylinder and shaft each projecting from the base so as to be substantially parallel and coaxial;
at least one resilient member between the cylinder and the shaft;
a spool coupled to the housing so as to be rotatable about the cylinder, the spool comprising a first element projecting between the cylinder and the shaft and engaging the at least one resilient member such that rotation of the spool causes section(s) of the at least one resilient member to radially contract; and
a clutch device mounted on the spool and comprising a second element projecting between the cylinder and the shaft to engage the at least one resilient member, the clutch device configured to carry a counterweight causing the second element to engage the at least one resilient member and bias the section(s) of the at least one resilient member to radially expand.

2. The window dressing control device of claim 1, wherein the at least one resilient member comprises two or more resilient members positioned coaxially about the central shaft.

3. The window dressing control device of claim 2, wherein the two or more resilient members comprise an even number of resilient members.

4. The window dressing control device of claim 1, comprising a reinforcing insert fixedly positioned against an inner cylindrical wall of the cylinder.

5. The window dressing control device of claim 4, wherein the reinforcing insert comprises a metallic material.

6. The window dressing control device of claim 4, wherein the reinforcing insert is integrally fused with the cylinder.

7. The window dressing control device of claim 4, wherein the reinforcing insert is configured to engage the coil section of the at least one resilient member, when the coil section radially expands.

8. The window dressing control device of claim 1, comprising an endless cord member coupled to the spool operable to drive rotation of the spool when pulled by a user.

9. The window dressing control device of claim 8, wherein the endless cord member comprises a beaded chain, a nylon cord, or a polyester cord.

10. The window dressing control device of claim 1, further comprising a hollow tube mounted on the clutch device and configured to support a window dressing, such that the counterweight carried by clutch device is proportional to the weight of the window dressing.

11. The window dressing control device of claim 1, further comprising a mounting bracket removably attached to the housing for mounting the housing to a support surface.

12. A window dressing control device comprising:
a housing defining a base, an axially extending hollow cylinder, and an axially extending central shaft, the cylinder and shaft each projecting from the base so as to be substantially parallel and coaxial;
at least one wrap spring positioned between the cylinder and the shaft, each at least one wrap spring comprising a coil section and radially extending tangs;
a spool coupled to the housing so as to be rotatable about the cylinder, the spool comprising a first cam element projecting between the cylinder and the shaft and engaging the at least one wrap spring, such that rotation of the spool causes the first cam element to bear on a first side of the tangs of the at least one wrap spring and cause the coil section(s) of the at least one wrap spring to radially contract; and
a clutch device mounted on the spool and comprising a second cam element projecting between the cylinder and the shaft to engage the at least one wrap spring, the clutch device being configured to carry a counterweight causing the second cam element to bear on a second side of the tangs of the at least one wrap spring and bias the coil section(s) of the at least one wrap spring to radially expand.

13. The window dressing control device of claim 12, wherein the at least one wrap spring comprises two or more wrap springs positioned coaxially about the central shaft.

14. The window dressing control device of claim 13, wherein the two or more wrap springs comprise an even number of wrap springs.

15. The window dressing control device of claim 12, further comprising a reinforcing insert fixedly positioned against an inner cylindrical wall of the cylinder.

16. The window dressing control device of claim 15, wherein the reinforcing insert comprises a metallic material.

17. The window dressing control device of claim 15, wherein the reinforcing insert is integrally fused with the cylinder.

18. The window dressing control device of claim 15, wherein the reinforcing insert is configured to engage the coil section of the at least one wrap spring when the coil section radially expands.

19. A roller shade end pin assembly, comprising:
an outer housing;
an end pin housing rotatably mounted coaxially within the housing, the end pin housing defining an open end opposite a base;
an end pin mounted coaxially within the end pin housing, the end pin having a first mounting projection;
at least one first resilient member disposed between the end pin and the end pin housing, the at least one first resilient member biasing the end pin away from the base of the end pin housing; and
a split end pin component slidably mounted on the end pin, the split end pin component having a second mounting projection; and
at least one second resilient member disposed between the split end pin component and the end pin housing, the at least one second resilient member biasing the split end pin component away from the base of the end pin housing;
wherein, when at maximum separation from the base of the end pin housing, the first mounting projection and the second mounting projection together define a cylindrical outer surface.

20. The roller shade end pin assembly of claim 19, wherein the first mounting projection is semi-cylindrical and the second mounting projection is semi-cylindrical.

21. The roller shade end pin assembly of claim 19, wherein the split end pin component is supported on the end pin such that movement of the split end pin component towards the base of the end pin housing exposes the first mounting projection of the end pin for engagement with a complementary first mounting projection of another roller shade end pin assembly.

22. The roller shade end pin assembly of claim 19, wherein the end pin comprises features that engage the end pin housing and limit movement of the end pin away from the base of the end pin housing.

23. The roller shade end pin assembly of claim 19, wherein the split end pin component comprises features that engage the end pin and limit movement of the end pin away from the base of the end pin housing.
